(19) United States
(12) Patent Application Publication
(10) Pub. No.: US 2008/0226106 A1
(43) Pub. Date: Sep. 18, 2008

(54) Method for adjusting a hearing device by using a morphometric feature of the hearing device wearer

(76) Inventor: Kristin Rohrseitz, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/899,569

(22) Filed: Sep. 6, 2007

(30) Foreign Application Priority Data
Sep. 7, 2006 (DE) 10 2006 042 085.3

(51) Int. Cl. H04R 25/00

(52) U.S. Cl. 381/314; 381/312

(57) ABSTRACT

The invention is based on the knowledge that there are morphometric features or parameters of the hearing device wearer, which enable an effective adjustment of the hearing device to the individual requirements of the wearer. In accordance with the invention, provision is made for a method for adjusting a hearing device with at least one input converter, one signal processing unit and one output converter, with at least one morphometric feature of a hearing device wearer being detected and transmitted to a facility for adjusting the hearing device and an adjustable parameter being adjusted by the signal processing facility of the hearing device in order to individually adjust the hearing device to the hearing device wearer as a function of the morphometric feature. In particular, this enables an age-related adjustment of the hearing device.

### CROSS REFERENCE TO RELATED APPLICATIONS

This application claims priority of German application No. 10 2006 042 085.3 filed Sep. 7, 2006, which is incorporated by reference herein in its entirety.

### FIELD OF THE INVENTION

The invention relates to a method for adjusting a hearing device with at least one input converter, one signal processing unit and one output converter by using a morphometric feature. The invention also relates to a hearing device, which can be adjusted to the hearing device wearer as a function of a morphometric feature.

### BACKGROUND OF THE INVENTION

Modem hearing devices can be adjusted to the individual requirements of their wearer. In particular, it is possible to adjust the acoustic pressure generated by the hearing device to the hearing threshold. This can occur in a frequency-dependent manner, such that different amplifications are set for different frequencies, said amplifications being adjusted to the hearing threshold of the hearing device wearer at the respective frequency.

The acoustic pressure is in this way also dependent inter alia on the size and geometry of the auditory canal. This requires a complicated and regular adjustment, particularly in the case of children, since their auditory canals are continuously changing during growth.

In addition, it was hitherto usual for ear-specific and frequency-specific auditory thresholds to be determined by measurement methods on the patient, and also for the acoustic characteristics of the auditory canal to be measured in order to be able to convert a respective auditory threshold into a corresponding acoustic pressure level in the auditory canal in a frequency-dependent manner. This can be carried out for instance with the aid of a facility for adjusting the hearing device, with the hearing device being connected to a coupler, by means of which the acoustic pressure level, which is output by the hearing device, can be determined in a frequency-dependent manner. The coupler has a standardized volume, which is to correspond to the volume of the auditory canal of the hearing device wearer, e.g. 2 cm³. As the coupler volume differs from the actual volume of the auditory canal of the hearing device wearer, particularly in the case of children, and since the geometry of the auditory canal also plays a role, it is necessary for the hearing device to be adjusted to the wearer with the aid of an adjustment parameter and/or adjustment factor. The use of the so-called RECD (real-ear-to-coupler difference) is known as an adjustment parameter. The hearing device can then be individually attuned to the hearing device wearer by using the RECD value.

A complex measurement in the auditory canal of the hearing device wearer is required in order to determine the RECD value, whereby a measuring facility must be inserted into the auditory canal. This measuring process is unpleasant for the hearing device wearer and can only be carried out with difficulty or not at all, particularly in the case of children, who frequently have a natural urge to move and only reluctantly remain seated for a measurement of this type.

Instead of using the RECD value or other corresponding adjustment parameters, such as the REUG (real-ear-unaided-gain) for instance, it is also possible to carry out an adjustment of the hearing device which is dependent on age. The fact that RECD values change as a function of age is also known (see for instance Bagatto M, Moodie S, Scollie S, Seewald R, Moodie S, Pumford J, Liu KP., Clinical protocols for hearing instrument fitting in the Desired Sensation Level method. Trends Amplif. 2005;9(4):199-226). In the case of an age-related adjustment of this type, there is no need for a complicated measurement to be carried out on the ear of the child. This has however shown that the use of an age-related adjustment is not very precise and discounts any individual differences within an age group.

### SUMMARY OF THE INVENTION

The aim of the present invention is to provide a method for adjusting hearing devices, which can be performed without a complex acoustic measurement on the ear of a hearing device wearer and enables an improved individual adjustment of the hearing device.

This object is achieved by the claims. The invention is based on the knowledge that morphometric features or parameters of the hearing device wearer exist that enables the hearing device to be effectively adjusted to the individual requirements of the wearer.

In accordance with the invention, provision is made for a method for adjusting a hearing device with at least one electroacoustic input converter, one signal processing unit and one electroacoustic output converter, which comprises the following steps:

a) Detecting at least one morphometric feature of a hearing device wearer and transmitting the morphometric feature to a facility for adjusting the hearing device;

b) Adjusting at least one adjustable parameter as a function of the morphometric feature.

The adjustable parameter is preferably adjusted as a function of the morphometric feature by assigning a command for adjusting the adjustable parameter of the hearing device to the morphometric feature by means of the facility for adjusting the hearing device and by adjusting the adjustable parameter by means of the signal processing facility of the hearing device in order to individually adjust the hearing device to the hearing device wearer.

A morphometric feature is a feature which relates to the design and comprises all features which can be measured on the design, e.g. height, distance dimensions such as for instance head diameter or intra-ocular distance, body or body part volume, surface area and weight. A morphometric feature can also be defined by a combination of different variables, such as for instance a proportion, e.g. the proportion of head diameter to height, the proportion of arm length to head diameter, or the body mass index (which is defined as BMI—Body Mass Index (in kg)/height² (in cm²)). In particular, an age-related and/or growth-related morphometric feature is preferred, i.e. a morphometric feature which changes as a function of the age and/or growth of the wearer. Preferred morphometric features are height, body weight, head circumference and head diameter, in particular the occipitofrontal diameter (measured from the forehead to the rear cranium) and the biparietal diameter (from temple to temple).

The term “Transmit the morphometric feature” means inputting or transmitting the morphometric feature into the facility in order to adjust the hearing device. It is possible to detect the morphometric feature by means of a measuring facility, e.g. a set of scales, a gauge, a measuring iron, a scanner or suchlike and then to manually enter the morphometric feature as a measured variable into the facility in order to adjust the hearing device or to transmit directly from the measuring facility to the adjustment facility in the form of a signal.

The term “a command for adjustment” means a command, a computing command, an algorithm, a factor, e.g. an amplification factor, a frequency response curve or in the broadest sense an item of information which can be used by the signal processing unit in order to adjust the amplification characteristics to the requirements of the hearing device wearer.

According to one aspect of the invention, the signal processing facility comprises the facility for adjusting the hearing device.

An “adjustable parameter” is a parameter, with the aid of which the acoustic characteristics of the hearing device can be adjusted to the requirements of the hearing device wearer, e.g. an amplification, in particular a frequency-specific amplification, a frequency response curve, an acoustic pressure level, in particular a frequency-specific acoustic pressure level, a control time, a noise suppression etc.

In particular, it is preferred that the adjustable parameter comprises an acoustic pressure level, more strongly preferred a frequency-dependent acoustic pressure level.

According to a preferred aspect of the invention, the morphometric feature or the command to adjust the at least one adjustable parameter to the hearing device is transmitted by means of wireless transmission. This particularly advantageously enables the hearing device to be adjusted without the hearing device wearer having to remove the hearing device from his/her ear. This is particularly advantageous when adjusting hearing devices for small children. After detecting the morphometric feature, e.g. after measuring the head diameter, a command for adjusting the hearing device is assigned to the morphometric feature and is wireless transmitted to the hearing device.

A digital signal processing facility is preferably used with the method. The adjustment can be carried out with support from appropriate software.

The use of values from the last adjustment is also preferred as an initial value for the adjustment of the hearing device.

The invention also relates to a hearing device system, comprising a hearing device unit with at least one input converter, a signal processing facility and an output converter, characterized in that the signal processing facility comprises an input possibility for inputting a morphometric feature and in response to the inputting of the morphometric feature adjusts at least one adjustable parameter.

In this case, an item of information relating to the morphometric feature is transmitted to the signal processing facility and the adjustment is carried out entirely in the hearing device.

The invention also relates to an arrangement for implementing the method according to the invention, comprising a hearing device with at least one electroacoustic input converter, one signal processing facility and one electroacoustic output converter and a facility for adjusting the hearing device with an input possibility for inputting an item of information relating to a morphometric feature of the hearing device wearer.

### BRIEF DESCRIPTION OF THE DRAWINGS

Further characteristics and advantages of the present invention are clarified with reference to the following exemplary embodiment and the appended figures, in which;

FIG. 1 shows a schematic diagram of the adjustment of a hearing device as claimed in the prior art, and

FIG. 2 shows a schematic illustration of the adjustment of a hearing device as claimed in the present invention.

### DETAILED DESCRIPTION OF THE INVENTION

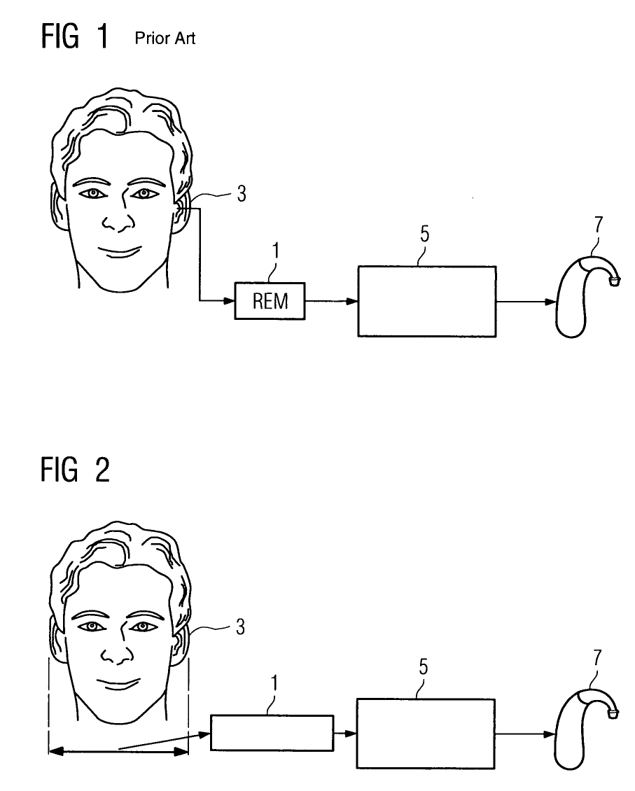

According to the prior art (FIG. 1), it is usual to perform a measurement 1 (Real-Ear-Measurement, REM) on the ear 3 of a hearing device wearer and to transmit the values obtained to a facility 5 for adjusting a hearing device 7 in order to adjust the hearing device to the individual requirements and/or anatomical characteristics of the wearer.

As shown in FIG. 2, a morphometric feature of the wearer is detected in accordance with the invention, such as for example the biparietal diameter as shown here, and is transmitted to a facility 5 for adjusting the hearing device 7.

In the facility for adjusting the hearing device, the detected morphometric feature is converted into a command for adjusting the hearing device. This can occur for instance in that the morphometric feature, e.g. the biparietal diameter, is correlated with a RECD value, which was obtained by a comparison with reference RECD values, which were experimentally obtained with test persons using REM measurements and are correlated with the measured value of the corresponding morphometric feature of the same test person, and were stored in a database for instance.

The method according to the invention allows the hearing device to be rapidly individually adjusted to the wearer without difficulty, without a complex measurement on the ear of the wearer being necessary.

1.-11. (canceled)

12. A method for adjusting a hearing device based on a morphometric feature of a wearer of the hearing device, comprising:
detecting the morphometric feature of the wear of the hearing device;
transmitting the morphometric feature to the hearing device; and
adjusting an adjustable parameter of the hearing device as a function of the morphometric feature so that the hearing device is individually adjusted to the wearer.

13. The method as claimed in claim 12, wherein the morphometric feature is transmitted to a device of the hearing device and compared with a reference value that is stored in a database.

14. The method as claimed in claim 13, wherein the device selects the adjustable parameter based on the comparison and sends out a command for adjusting the adjustable parameter to a signal processing device of the hearing device.

15. The method as claimed in claim 12, wherein the morphometric feature is transmitted to a signal processing device of the hearing device and compared with a reference value that is stored in a database.

16. The method as claimed in claim 15, wherein the signal processing device selects the adjustable parameter based on the comparison and adjusts the adjustable parameter accordingly.

17. The method as claimed in claim 12, wherein the adjustable parameter is selected from the group consisting of: an amplification, a frequency-specific amplification, a frequency response curve, an acoustic pressure level, a frequency-specific acoustic pressure level, a control time, and a noise suppression.

18. The method as claimed in claim 12, wherein the morphometric feature of the wear of the hearing device comprises an age-related or growth-related feature.

19. The method as claimed in claim 12, wherein the morphometric feature of the wear of the hearing device is selected from the group consisting of: height, body weight, body circumference, biparietal diameter, and occipitofrontal diameter.

20. A hearing device, comprising:
an electroacoustic input converter that converts an acoustic input signal to an electrical signal;
a device that receives a morphometric feature of a wearer of the hearing device;
a signal processing device that adjusts an adjustable parameter of the hearing device by a command sent out from the device based on the morphometric feature and processes the electrical signal based on the adjustable parameter; and
an electroacoustic output converter that converts the processed electrical signal to an acoustic output signal.

21. The hearing device as claimed in claim 20, wherein the device:
compares the morphometric feature with a reference value stored in a database, selects the adjustable parameter based on the comparison, and
sends the command out to the signal processing device accordingly.

22. The hearing device as claimed in claim 20, wherein the adjustable parameter is selected from the group consisting of: an amplification, a frequency-specific amplification, a frequency response curve, an acoustic pressure level, a frequency-specific acoustic pressure level, a control time, and a noise suppression.

23. The hearing device as claimed in claim 20, wherein the morphometric feature of the wear of the hearing device comprises an age-related or growth-related feature.

24. The hearing device as claimed in claim 20, wherein the morphometric feature of the wear of the hearing device is selected from the group consisting of: height, body weight, body circumference, biparietal diameter, and occipitofrontal diameter.

25. The hearing device as claimed in claim 20, wherein the signal processing device is a digital signal processing device.

26. A hearing device, comprising:
an electroacoustic input converter that converts an acoustic input signal to an electrical signal;
a signal processing device that:
receives a morphometric feature of a wearer of the hearing device, adjusts an adjustable parameter of the hearing device based on the morphometric feature, and
processes the electrical signal based on the adaptable parameter; and
an electroacoustic output converter that converts the processed electrical signal to an acoustic output signal.

27. The hearing device as claimed in claim 26, wherein the signal processing device:
compares the genetic feature with a reference value stored in a database,
selects the adjustable parameter based on the comparison, and
adjusts the adjustable parameter accordingly.

28. The hearing device as claimed in claim 26, wherein the adjustable parameter is selected from the group consisting of: an amplification, a frequency-specific amplification, a frequency response curve, an acoustic pressure level, a frequency-specific acoustic pressure level, a control time, and a noise suppression.

29. The hearing device as claimed in claim 26, wherein the morphometric feature of the wear of the hearing device comprises an age-related or growth-related feature.

30. The hearing device as claimed in claim 26, wherein the morphometric feature of the wear of the hearing device is selected from the group consisting of: height, body weight, body circumference, biparietal diameter, and occipitofrontal diameter.

31. The hearing device as claimed in claim 26, wherein the signal processing device is a digital signal processing device.
